(19) United States
(12) Patent Application Publication
(10) Pub. No.: US 2007/0162383 A1
(43) Pub. Date: Jul. 12, 2007

(54) Fundraising systems and methods

(76) Inventor: Mathew Fass, Los Angeles, CA (US)

Correspondence Address: PAPARELLA & ASSOCIATES, PLC, 930 N. WASHINGTON AVE., LANSING, MI, 48906, US

(21) Appl. No.: 11/327,019

(22) Filed: Jan. 9, 2006

(51) Int. Cl. G06Q 40/00

(52) U.S. Cl. 705/39

(57) ABSTRACT

A method implemented by a fundraising system is provided. The fundraising system includes at least one fundraising apparatus, at least one fundraising apparatus operator, and at least one donating person. The method includes: receiving by the apparatus operator an amount of funds from a donating person, said amount corresponding to at least one resting location of a dial that is spun at least one time by the donating person, said resting location occurring after the dial has been spun by the donating person.

### BACKGROUND

An example of an existing method for fundraising includes asking people to donate amounts as determined by the donating persons or as determined by the receiving charity. However, existing systems and methods for fundraising are often insufficient for raising desired amounts of charitable funds. Therefore, there exists a need for improved systems and method for fundraising.

### SUMMARY

An embodiment of a method implemented by a fundraising system is provided. The fundraising system includes at least one fundraising apparatus, at least one fundraising apparatus operator, and at least one donating person. The method includes: receiving by the apparatus operator an amount of funds from a donating person, said amount corresponding to at least one resting location of a dial that is spun at least one time by the donating person, said resting location occurring after the dial has been spun by the donating person.

Other embodiments of the invention will become apparent upon examination of the following drawings and detailed description. It is intended that all such additional embodiment, systems, methods, features and advantages be included within this description, be within the scope of the present invention, and be protected by the accompanying claims.

### BRIEF DESCRIPTION OF THE DRAWINGS

FIG. 1 shows a fundraising system using a fundraising apparatus, which will be further described in FIGS. 2 through 5.

FIG. 2 provides an embodiment, among others, of a fundraising apparatus.

FIG. 3 shows one embodiment of the dial area on a fundraising apparatus.

FIG. 4 depicts a dial area such that there are four areas indicating funds to be donated.

FIG. 5 represents a specific example of FIG. 2 in fundraising apparatus.

FIG. 6 is a flow chart depicting an embodiment of a method implemented by a fundraising apparatus provider.

FIG. 7 is a flow chart depicting an embodiment of a method implemented by a donating person.

FIG. 8 is a flow chart depicting an embodiment of a method implemented by an apparatus operator.

### DETAILED DESCRIPTION OF THE PREFERRED EMBODIMENTS

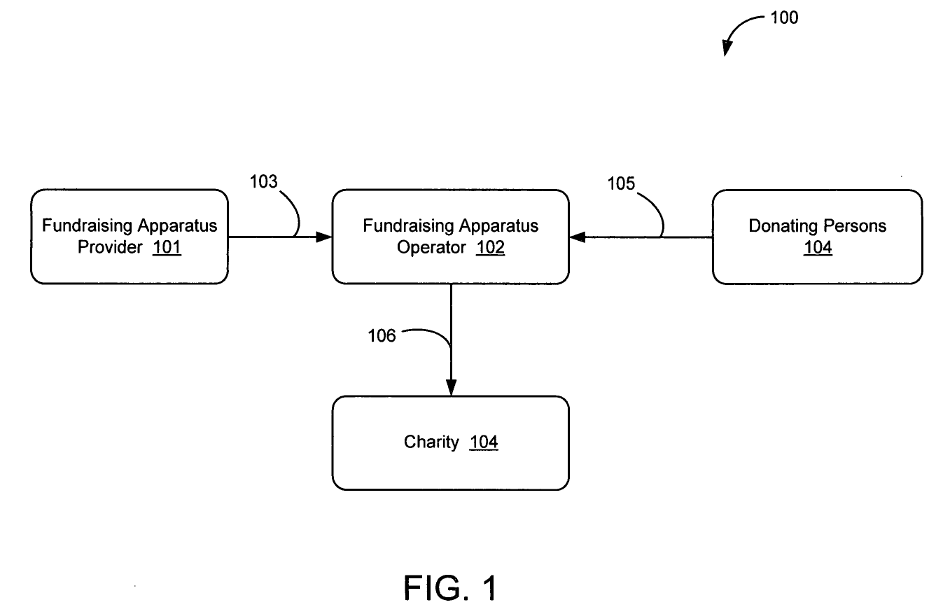

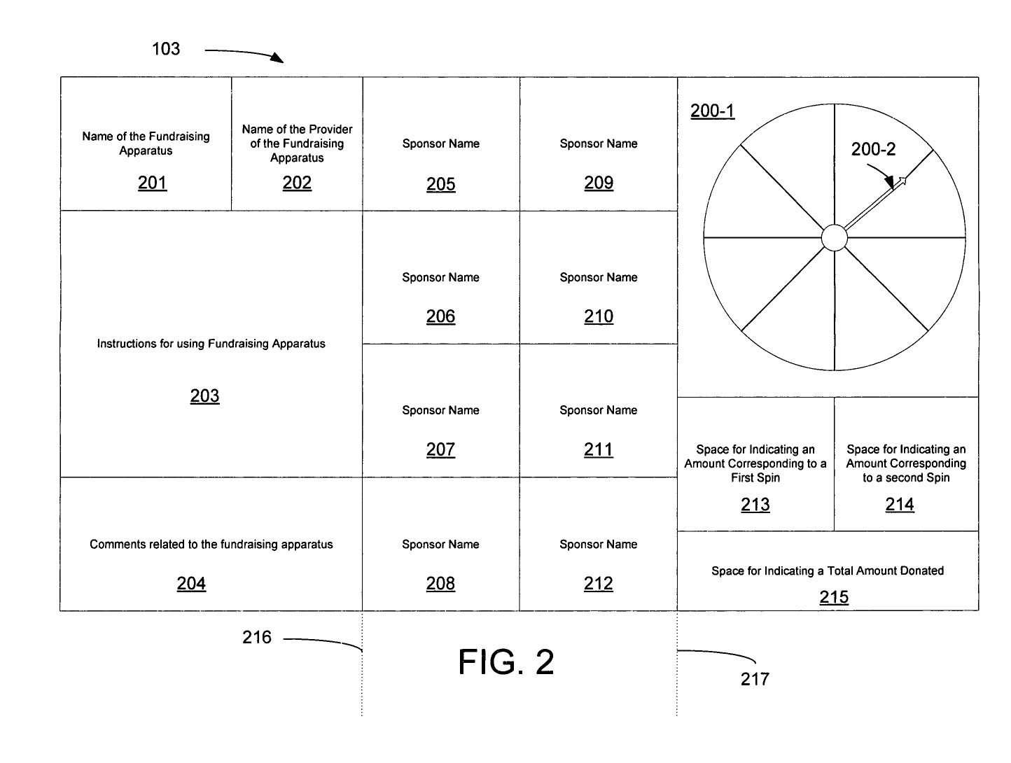

FIG. 1 shows a fundraising system 100 using a fundraising apparatus, which will be further described in FIGS. 2 through 5. According to fundraising system 100, the fundraising apparatus provider 101 provides fundraising apparatus 103 to fundraising apparatus operator 102. Donating persons 104 play a fundraising game, which is embodied in a fundraising apparatus 103, and subsequently give funds 105 to fundraising apparatus operator 102. Fundraising apparatus operator 102 then gives some of all of such funds 106 to a chosen charity. Said charity may in one embodiment be the fundraising apparatus operator 102 itself.

FIG. 2 provides an embodiment, among others, of a fundraising apparatus 103. In this embodiment, the fundraising apparatus comprises a tri-fold board with folds occurring at fold lines 216 and 217. In the upper-right hand corner of the fundraising apparatus 103 is the dial area 200-1, in this embodiment comprising eight segmented sections each of which may correspond to a donation amount, and one spinnable dial 200-2 which when spun may be configured to make a unique clicking sound and which when stopped may indicate an amount to be donated by donating persons 104. Other embodiments of dial area 200-1 will be discussed.

The fundraising apparatus 103 comprises areas 201 through 215 in addition to the dial area 200-1. Area 201 portrays the name of the fundraising apparatus 103 (e.g., Spinners) while area 202 gives a name of the fundraising apparatus provider 101 (e.g., ABC Fundraising). Below these two areas resides area 203, instructions for using fundraising apparatus 103. Comments that are related to the fundraising apparatus 103 may be placed in area 204, located below instructions 203.

In the center of fundraising apparatus 103 may be a pad of coupon sheets (e.g., 50 sheets, among other embodiments), with the intention that each donating person 104 may receive one sheet in return for two spins of spinnable dial 200-2 and subsequently donating the corresponding donation amounts indicated on the dial area 200-1 by the spinnable dial 200-2. Coupons may correspond to sponsors whose names and the value of their coupons may be printed in areas 205 through 212.

The donated amounts may be recorded in areas 213 and 214 which may comprise 50 detachable sheets of paper with spaces for writing the amounts indicated by the first and then the second spin. Below these areas 213 and 214 , and on the same sheets of paper as areas 213 and 214, resides area 215, a space for indicating the total amount donated. The area 215 may be torn off from the corresponding page and provided to the donating person. There may be many pages in each fundraising apparatus 103 that include many respective areas 215 (e.g., 50 pages or sheets that include 50 respective areas 215 that may be torn off from the respective pages or sheets).

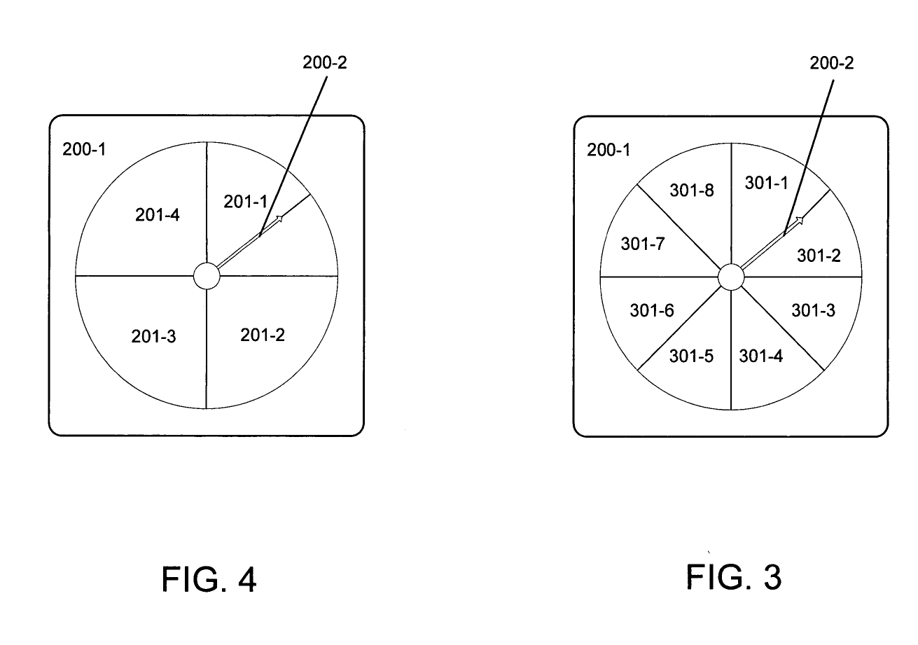

FIG. 3 shows one embodiment of the dial area 200-1 on fundraising apparatus 103. In this embodiment, spaces 301-1 through 301-8 provide eight areas in which to place varying amounts of funds to be donated. Spinnable dial 200-2 may stop at one of these areas and indicate the amount of funds to be donated.

In another embodiment, FIG. 4 depicts dial area 200-2 such that there are four areas 401 through 404 indicating funds to be donated. Spinnable dial 200-2 may hence stop at one of these areas indicating the funds to be donated. Other embodiments may include any number of donation amounts, depending on a desired implementation.

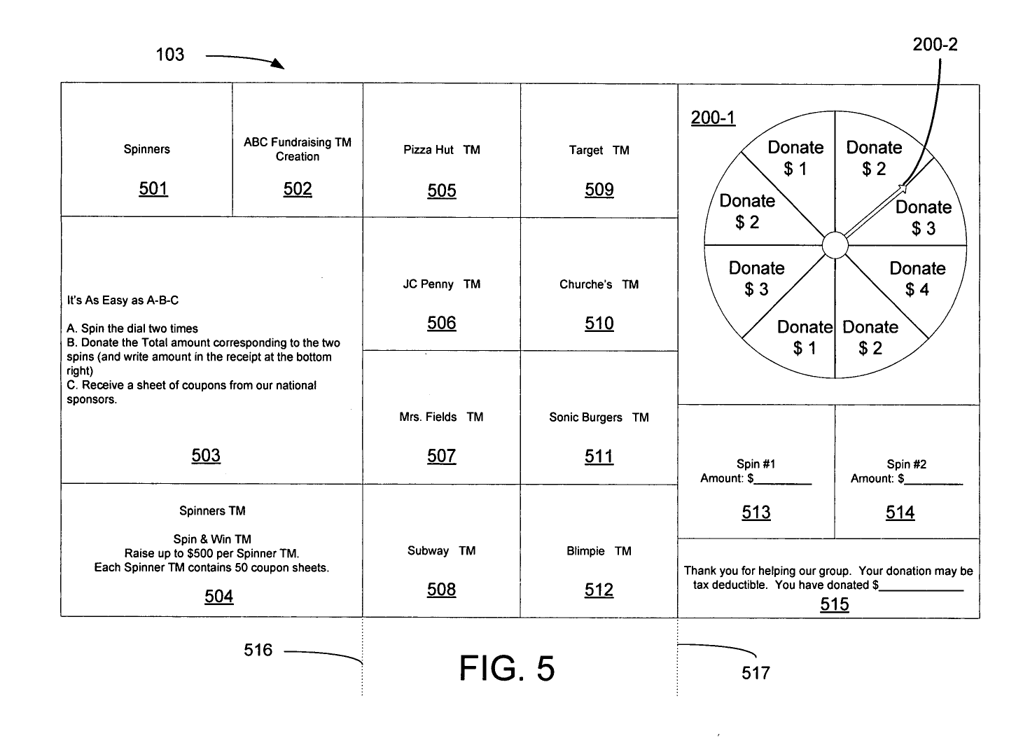

FIG. 5 represents a specific example of FIG. 2 in fundraising apparatus 103. Areas 501 through 504 contain pertinent information regarding one source and the use of fundraising apparatus 103. Areas 505 through 512 portray possible sponsor coupons contained on individual and detachable sheets of paper (e.g., 50 sheets). Areas 513 through 515 show a first of several (e.g., 50) detachable sheets of paper to be given as receipts for tax deductions that indicate the individual amounts of each spin (areas 413 and 414) and the total amount of funds donated (area 415). Dial area 200-2 in this embodiment comprises eight donation spaces ranging in donation amounts from $1.00 to $4.00.

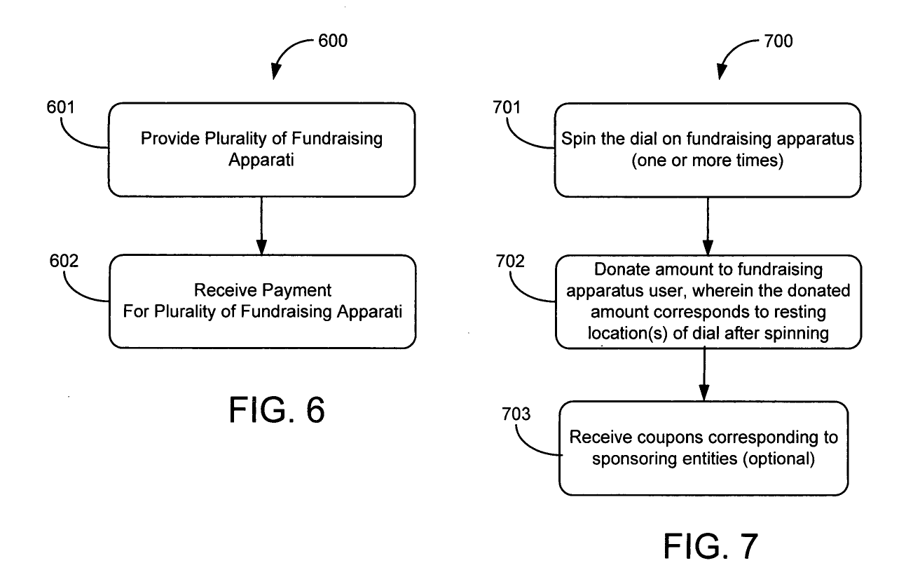

FIG. 6 is a flow chart depicting an embodiment of a method 600 implemented by a fundraising apparatus provider 101. Herein, the fundraising apparatus provider supplies a plurality of fundraising apparatuses (step 601) and receives payment for such apparatuses (step 602). Other methods may be employed. The transaction described in method 600 may occur between the provider 101 and a charity that is to benefit from the fundraising or between the provider 101 and an operator of the apparatuses.

FIG. 7 is a flow chart depicting an embodiment of a method 700 implemented by a donating person 104. Herein, the donating person spins a dial (step 701), donates the amount(s) indicated by the spinnable dial 200-2 to fundraising apparatus operator 102 (step 702), and receives coupons (step 703) corresponding to sponsors of the fundraising system.

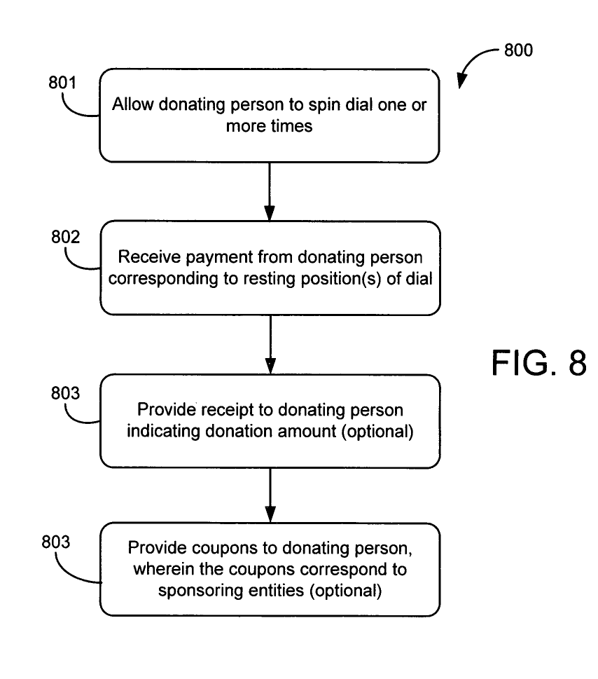

FIG. 8 is a flow chart depicting an embodiment of a method 800 implemented by an apparatus operator. The method 800 includes allowing a donating person to spin a dial one or more times (step 801), receiving a payment from the donating person corresponding to resting position(s) of dial (step 802), providing a receipt to donating person indicating the donation amount (optional step 803), and providing coupons to the donating person, wherein the coupons correspond to sponsoring entities (optional step 804).

It should be emphasized that the above-described embodiments, methods and systems of the present invention are merely possible examples, among others, setting forth a clear understanding of the principles of the invention. Many variations and modifications may be made to the above-described embodiments, methods and systems of the invention without departing substantially form the principles of the invention. All such modifications and variations are intended to be included herein within the scope of this disclosure and present invention and to be protected by the following claims.

What is claimed is:

1- A method implemented by a fundraising system, said fundraising system comprising at least one fundraising apparatus, at least one fundraising apparatus operator, and at least one donating person, said method comprising:
receiving by the apparatus operator an amount of funds from a donating person, said amount corresponding to at least one resting location of a dial that is spun at least one time by the donating person, said resting location occurring after the dial has been spun by the donating person; and

2- the method of claim 1, further comprising:
providing by the apparatus operator to the donating person with at least one discount coupon corresponding to at least one sponsor of the fundraising system.

3- the method of claim 1, further comprising:
providing by the apparatus operator to the donating person with a plurality of coupons corresponding to a plurality of sponsors of the fundraising system.

4- the method of claim 1, wherein at least a portion of the amount of funds is provided to a fundraising recipient.

5- the method of claim 1, wherein the fundraising apparatus is sold to the fundraising recipient by a fundraising apparatus provider.

6- the method of claim 1, wherein the amount of funds is a sum corresponding to a plurality of resting locations of the dial that is spun a plurality of times by the donating person.

7- the method of claim 1, further comprising:
providing by the apparatus operator to the donating person with a receipt indicating the amount of funds.
